(19) United States
(12) Patent Application Publication
(10) Pub. No.: US 2006/0157967 A1
(43) Pub. Date: Jul. 20, 2006

(54) Seat belt system for automobile

(76) Inventor: Paul R. Edwards, Oak Park, IL (US)

Correspondence Address: Charles C. Valauskas;BANIAK PINE & GANNON, Suite 1200, 150 N. Wacker Drive, Chicago, IL, 60606, US

(21) Appl. No.: 11/331,956

(22) Filed: Jan. 13, 2006

Related U.S. Application Data
(60) Provisional application No. 60/644,079, filed on Jan. 14, 2005.

(51) Int. Cl. B60R 22/00; A47D 15/00

(52) U.S. Cl. 280/801.1; 297/485

(57) ABSTRACT

A passive restraint system for use in a vehicle includes a seat belt portion and a shoulder belt portion. A shoulder harness restraint is provided that includes a length of material and a device which connects the shoulder belt portion to the seat and functions to retain the shoulder belt to the wearer when the seat is either inclined or upright.

This application claims the benefit of Provisional Application No. 60/644,079, filed Jan. 14, 2005.

### FIELD OF THE INVENTION

The present invention relates to safety equipment for use in a motorized vehicle. In particular, the present invention relates to a passive restraint system, i.e., including seat belt equipment. More particularly, the present invention relates to a shoulder harness restraint that increases the utility of a three point passive restraint system for use in a motorized vehicle.

### BACKGROUND OF THE INVENTION

There is widespread use of belt-type passive restraint systems in motorized vehicles. It will be understood that motorized vehicles includes cars, trucks, vans, buses, SUVs, airplanes, boats and so on. Generally, and for purposes of the present application, a passive restraint system includes a conventional three point harnesses including shoulder and seat belt portions. Many countries require that driver and passengers of a motor vehicle wear a passive restraint system at all times during operation of the vehicle.

Typically, a passive restraint system for a motorized vehicle includes two belt portions: a seat belt, and a shoulder belt. The seat belt includes a length of seat strap material typically anchored at a first end—termed “seat attachment end”—to the floor or frame member of the vehicle. To a coupling end of the seat strap material, a quick release coupling or buckle is fastened. The shoulder belt includes a shoulder length of shoulder strap material, at one end of which—termed “shoulder attachment end”—the shoulder belt is attached to the vehicle. Both the seat strap material and the shoulder strap material may be attached to a locking spool mechanism, a locking cam, or friction device to gradually play out the seat and/or shoulder strap material for purposes of attaching the quick release coupling or buckle to a receiver that is attached to a vehicle floor. Of course, different restraint systems may be mounted differently.

As is well known, when fastened in place, the seat strap material of the seat belt component of the system lies across the upper thighs or lap of the user. The shoulder strap material of the shoulder belt component of the system angles from over a shoulder of the user, across the chest and downwardly across the lower thorax to attach to a common coupling with the seat belt.

The general intention of a passive restraint system is to prevent the user from being ejected from the vehicle during an accident, and ideally, from forcefully contacting interior features of the vehicle. However, passive restraint systems are designed to fit closely to the user when the occupied seat is in an upright position. In this configuration, the seat and shoulder belts are designed to closely follow the contours of the user's body and prevent the user from being moved a significant distance during, for example, a frontal vehicle accident.

Modern vehicles are often supplied with seats which have a tilting mechanism and may be inclined to permit the user a more relaxed seating position. However, in the inclined position, the shoulder belt is less effective at restraining the user or no longer functions to hold the user securely in the seat. This is due, at least in part, to the fact that the shoulder attachment end of the shoulder strap is fixed with respect to the seat and, when inclined, the seat and user are moved back from the shoulder attachment end and thus the shoulder strap becomes spaced from the user.

Therefore, there is a demand for an improved seat belt system which is better suited to use in a vehicle with seats that incline and remain functional over a range of seat angle. The present invention satisfies the demand.

### SUMMARY OF THE INVENTION

The present invention provides, in one embodiment, a passenger restraint system in a vehicle for restraining an occupant, including a lap-shoulder belt assembly having a shoulder belt and a seat belt. The shoulder belt includes a shoulder length of shoulder strap material having a shoulder attachment end attached to the vehicle and a shoulder coupling end attached to a quick-release coupling. The shoulder belt is sized and positioned to extend over one of the shoulders and transversely across the chest of the occupant. The seat belt includes a seat attachment end attached to the vehicle and a seat coupling end attached to the quick-release coupling. A shoulder harness restraint is provided with a first terminal end detachably mounted to a seat of the vehicle and a second terminal end slidably attached to the shoulder belt. The shoulder harness restraint includes a harness length of harness material and is sized and shaped and has sufficient flexibility to provide a close fit of the shoulder belt to the occupant when the seat of the vehicle is in either of an upright and an inclined condition or positions between.

The invention provides the foregoing and other features, and the advantages of the invention will become further apparent from the following detailed description of the presently preferred embodiments, read in conjunction with the accompanying drawings. The detailed description and drawings are merely illustrative of the invention and do not limit the scope of the invention, which is defined by the appended claims and equivalents thereof.

### BRIEF DESCRIPTION OF THE DRAWINGS

FIG. 1 is a front view of a vehicle seat including a passive restraint system according to an embodiment of the present invention.

FIG. 2 is a side view of a vehicle seat and the passive restraint system of FIG. 1.

FIG. 3 is a side view of a vehicle seat in an inclined position and the passive restraint system of FIG. 1.

FIG. 4 shows a strap portion according to an embodiment of the passive restraint system of the present invention.

FIG. 5 shows a fastening plate according to an embodiment of the passive restraint system of the present invention.

FIG. 6 shows a clip portion of the passive restraint system according to an embodiment of the present invention.

FIGS. 7A-C show views of a chair fastening plate according to an embodiment of the present invention.

FIG. 8 shows the strap of FIG. 4 in an unfolded condition.

FIG. 9A shows a length of webbing material.

FIG. 9B shows the length of webbing material of FIG. 9A folded end over end.

FIG. 10 shows a modified top seat belt mount.

FIG. 11 shows a vehicle seat including a passive restraint system according to another embodiment of the present invention.

### DETAILED DESCRIPTION OF THE PRESENTLY PREFERRED EMBODIMENTS

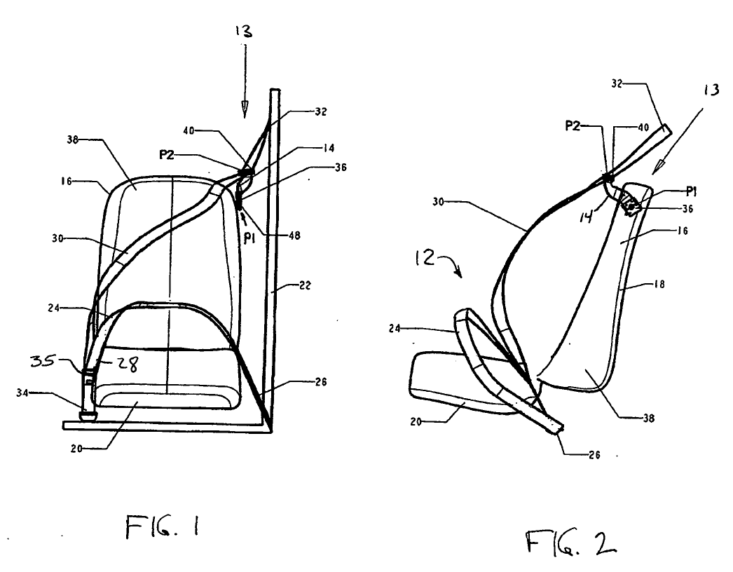

Referring to FIGS. 1-3, a passenger restraint system 13 according to the present invention generally includes a three point passive restraint system or lap-shoulder belt assembly 12 combined with a shoulder harness restraint 14. The figure shows the system in use as it may be configured if an occupant was in place on the seat (seated occupant not shown).

The restraint system 13 is designed to closely fit to and hold a vehicle occupant in a seat in both upright and inclined seat positions. The restraint system 13 is attached partly to a conventional inclinable seat 16. The seat 16 includes a seat back 18, which is the generally vertical member of the seat, and which is sized and shaped to contact the back of the seat occupant. The seat 16 includes a seat bottom 20 which is the generally horizontal member of the seat, and which is sized and shaped to receive the lower portions of the seat occupant including the occupant's buttocks. Also symbolically depicted in these figures is a vehicle frame member 22, which serves as an anchor point for portions of the restraint system, and which will be described in more detail below.

The restraint system 13 includes a seat belt 24, including seat belt first and seat belt second ends, the first of which is a seat attachment end 26, and a second end, which is a seat belt coupling end 28 which is connected to a quick release coupling 35. The seat belt 24, when positioned on a vehicle occupant, extends across upper thighs or a lap area of the occupant. The seat belt 24 is thusly attached to the vehicle and fitted and secured over the occupant in a conventional manner.

The restraint system 13 includes a shoulder belt 30, including upper and lower ends, the upper of which is a shoulder attachment end 32 which, when affixed in place over a vehicle occupant extends over a shoulder and transversely across the chest of the occupant as shown.

The shoulder attachment end 32 may be attached to the frame 22 of the vehicle (not shown). The lower end, which is a shoulder coupling end 34 is attached to a quick-release coupling 35 as is known along with the seat belt coupling end 28. The shoulder belt 30 extends over and is fitted and secured over the occupant in a conventional manner.

The present restraint system 13 is based on an otherwise conventional three point restraint system with the further addition of a shoulder harness restraint 14. The shoulder harness restraint 14 has a first terminal end 36 that may connect to an outside face 38 of the seat back 18. The shoulder harness restraint 14 connects to the outside face 38 at a point P1, which is approximately at shoulder height of the occupant but below the shoulder belt 30 attachment to the frame 22. Other suitable connection points are contemplated by the present invention.

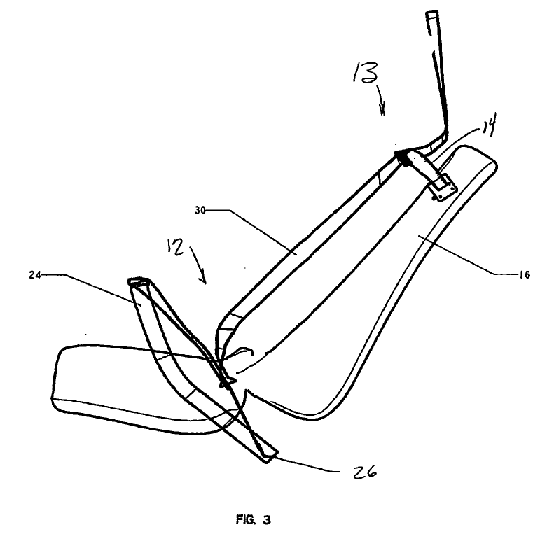

A second terminal end 40 attaches to the shoulder belt 30 at point P2 between where the shoulder attachment end 32 attaches to the frame 22 and where the shoulder belt crosses the chest area of the occupant. The means of attaching the first terminal end 36 and the second terminal end 40 will be described in more detail below. Functionally, and referring in particular to FIG. 3, it can be seen that inclining the seat 16, causes the shoulder harness restraint 14 to pull the shoulder belt 30 toward the seat 16 when the seat is moved from an upright position (FIG. 2) to the position shown in FIG. 3, and thus keeps the shoulder harness in close contact with the wearer.

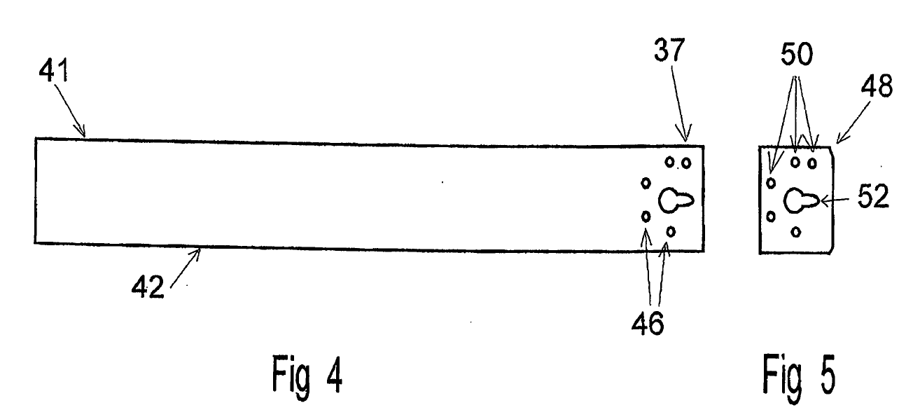

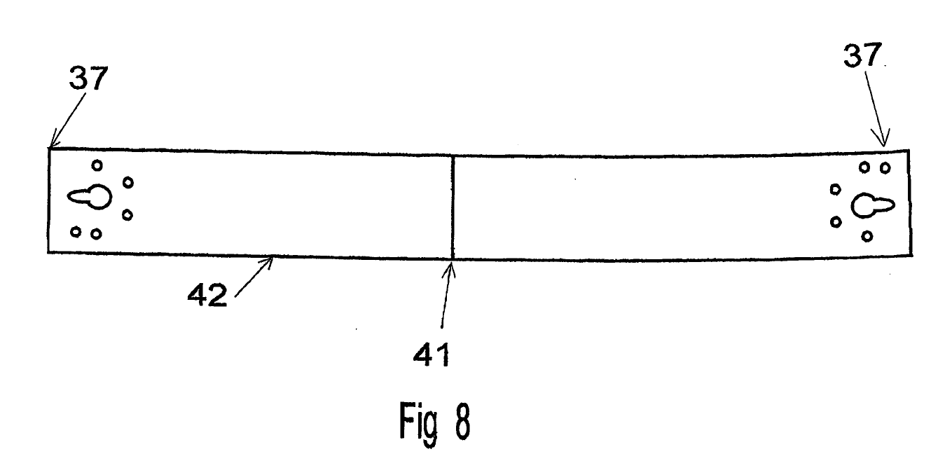

Turning to FIG. 4, the shoulder harness restraint 14 includes a length of seat belt material 42, typically a webbed nylon, sufficient to reach from the seat attachment point P1 to the shoulder belt 30 attachment point P2 (See FIG. 1) when doubled upon itself. At first terminal belt end 37, the length of seat belt material 42 includes an opening 44 and a plurality of rivet holes 46. At second terminal belt end 41, the length of seat belt material 42 is folded. When unfolded, the length of seat belt material 42 appears as shown in FIG. 8.

Turning to FIG. 5 a fastening plate 48 is shown. The fastening plate 48 is essentially rectangular, and is sized to be attached to first terminal belt end 37 of the length of seat belt material 42. When so attached, the fastening plate 48 is fixed to the length of seat belt material 42, by way of a plurality of rivets 50 in the same pattern as the rivet holes 46 (FIG. 5). Also, a bolt hole 52 aligns with the opening when the fastening plate is fixed to the first terminal belt end 41 of the length of seat belt material 42 (FIG. 4).

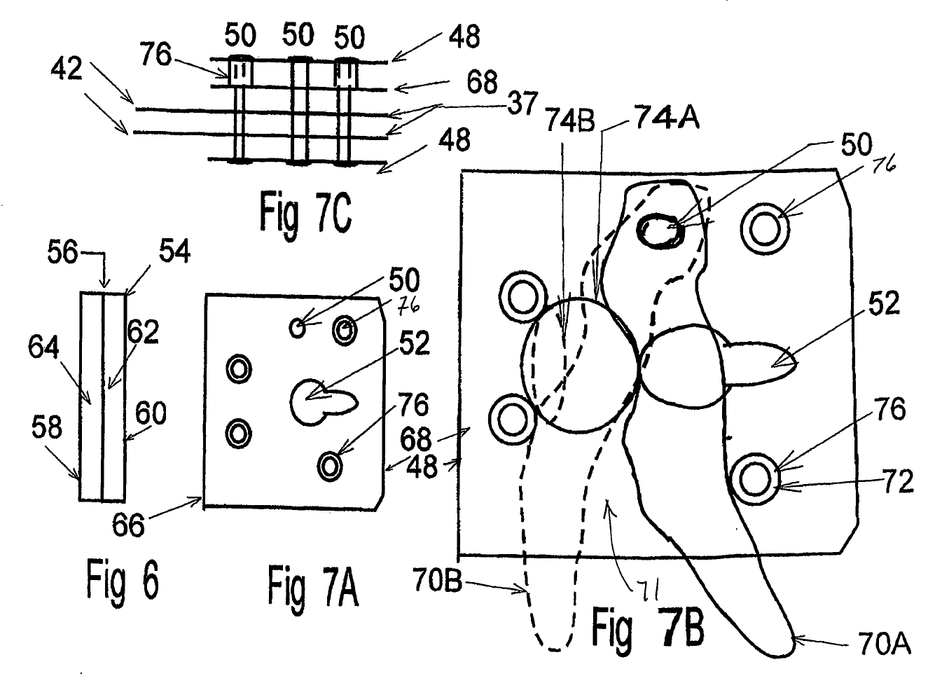

The length of seat belt material 42 is fastened to the shoulder belt 30, and referring to FIG. 6, a buckle 54 is shown for that purpose. It will be understood that any suitable method or means of slidably attaching the length of seat belt material 42 to the shoulder belt 30 is contemplated by the present invention. The buckle 54 is a rectangular member having a center post 56 spaced between a first outer post 58 and a second outer post 60. The shoulder belt 30 passes through the shoulder belt space 62 defined between the second outer post 60 and the center post 56. The shoulder belt 30 is permitted to slide through the shoulder belt space 62.

The second terminal belt end 41 of the length of seat belt material 42 is folded around the first post 58 such that a first span of seat belt material (not shown) passes outside of the first post 58 and a second span (not shown) passes through the space 64 defined between the first post 58 and the center post 56.

FIGS. 7A, 7B show an embodiment of the fastening plate 48 for fastening the first terminal belt end 37 of the length of seat belt material 42 to the side of the seat 16 at P1 (See FIG. 1 and FIG. 4). The fastening plate 48 permits the first terminal belt end 37 of the length of seat belt material 42 to be releasably fastened to the seat 16 (See FIG. 1 and FIG. 4). The fastening plate 48 includes an outer plate 66, which is roughly rectangular, and a matching inner plate 68 (see FIG. 7B) which is held in a spaced configuration from the outer plate 66 by any known means in the art, such as spacers, washers, bushings and so on (not shown). Both the outer and inner plates 66, 68, are aligned and held in a parallel configuration when fastened together by rivets 50, and/or pins 76 or the like and include a central bolt hole 52.

Turning to FIG. 7B, and also referring to FIG. 7A, a release lever 70A, 70B is pivotally mounted between outer and inner plates 66, 68 to form a quick release feature 71 therewith. In a first position, denoted by the solid outline A, the lever 70 partially overlaps central bolt hole 52 so as to secure the fastening plate 48 on a head of a fastener (not shown) fastened to the seat at P1 (See FIG. 1). Moving the lever 70 into the position denoted by broken line B permits the head of a fastener to pass through the central bolt hole 52. The travel of the lever 70 is limited in the closed position by a stop 72, which may be a rivet, or a rivet with a washer, bushing or any means for providing a suitable stop. The lever 70 is biased in the closed position by a spring 74 or a similar device. The spring 74 is held in position by a pair of spaced rivets, screws, pins 76 or any suitable means of holding the spring and is shown in an uncompressed condition at 74A and a compressed condition 74B.

In this manner, if the seat 16 (See FIG. 1) is capable of being folded into the floor, for example, removed from the vehicle or moved significantly from an upright or inclined position, the shoulder harness restraint 14 may be disconnected from the seat, permitting the seat to be moved or removed from the vehicle. Turning to FIG. 7C, the seat belt material 42 is captured by flanking fastening plates 48, which are outer plates 66 (see FIG. 7A). An inner plate 68 is interposed between the seat belt material 42, and in particular, the first terminal belt end 37 and fastening plate 48, which is an outer plate 66. The plates, 48, 68 and seat belt material 42 may be fastened by rivets 50 and pins 76 as shown.

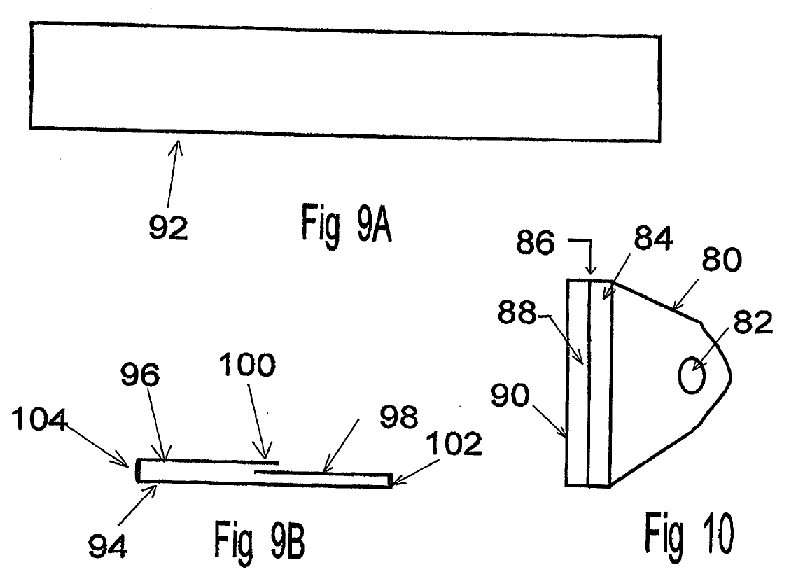

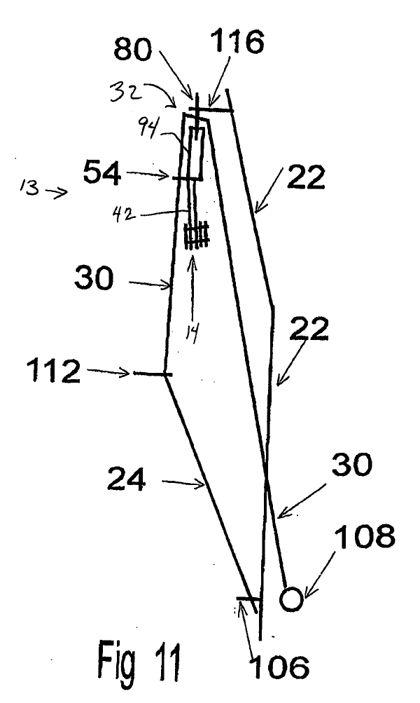

FIG. 9A is a length of seat belt material 92, or an equivalent thereto. The length of seat belt material 92 may be formed into a folded retainer belt 94, as shown in FIG. 9B by overlapping a top fold 96 over an under folded portion 98 and fastened at 100, by sewing, for example. The folded and fastened retainer member 94 thus provides a first end 102 which may be wrapped about a seat belt mounting bracket (see FIG. 10, for example) and a second end 104, which may be wrapped about post 56 of buckle 54 (see FIG. 6). When used in this fashion, the folded and fastened retainer member 94 holds the buckle 54 in place on the seat belt shoulder strap 30 (see FIG, 1).

Turning to FIG. 10, a modified seat belt buckle 80 according to an embodiment of the invention includes a mounting hole 82 for attaching the seat belt buckle to a frame member of the vehicle (not shown) and a seat belt passage 84 defined in part by loop 86. A seat belt support passage 88 for the folded retainer member 94 (see FIG. 9B) is defined generally by outside loop 90 and loop 86.

FIG. 11 shows a passenger restraint system 13 with the addition of the retainer member 94. The system 13 includes a shoulder belt portion 30 passing through modified seat belt buckle 80 at shoulder attachment end 32 thereof and is attached to a locking reel 108. The modified seat belt buckle 80 (see FIG. 10) is attached to vehicle frame 22 with a bolt 116 or the like. The shoulder belt portion 30 passes through releasable seat belt buckle 112 and transitions to become the lap or seat belt portion 24. The seat belt portion 24 is fastened to fastener 106, in a conventional fashion.

Retainer member 94 also passes through modified seat belt buckle 80 and buckle 54 to keep buckle 54 in place where the shoulder belt portion 30 passes through. Also attached to buckle 54 is the length of seat belt material 42, which is attached to a seat (see FIG. 1) by way of shoulder harness restraint 14.

In this manner, the shoulder belt portion 30 is kept close to a passenger when a seat 20 (see FIG. 1) is inclined and a retaining member 94 prevents the shoulder harness restraint 14 from becoming displaced.

It should be understood that the above description of the preferred embodiment, alternative embodiments, and specific examples are given by way of illustration and not limitation. For example, the features described herein could be incorporated into any variation of vehicle. Many changes and modifications within the scope of the present embodiments may be made without departing from the spirit thereof, and the present invention includes all such changes and modifications.

What is claimed is:

1. A restraint system in a vehicle with an occupant restrained by at least the occupant's chest, for restraining an occupant generally in a seat of the vehicle so that shoulders and buttocks of the occupant remain in contact with a front surface of the seat, comprising:
a lap-shoulder belt assembly including a shoulder belt and a seat belt;
said shoulder belt including a shoulder attachment end attached to the vehicle and a shoulder coupling end attached to a quick-release coupling;
said seat belt including a seat attachment end attached to the vehicle and a seat belt coupling end attached to said quick-release coupling; and
a shoulder harness restraint including a first terminal end mounted to a seat of the vehicle and a second terminal end slidably attached to said shoulder belt.

2. The passive restraint system of claim 1, wherein said shoulder belt is sized and positioned to extend over one of the shoulders and transversely across the chest of the occupant

3. The passive restraint system of claim 1, further including a quick release fastening plate attached to said first terminal end of said shoulder harness restraint to permit said first terminal end to releasably attach to the seat.

4. The passive restraint system of claim 1, wherein said shoulder harness restraint is sized and shaped to provide a close fit of said shoulder belt to the occupant when the seat of the vehicle is in either of an upright and an inclined condition.

5. The passive restraint system of claim 1, further including a harness restraint buckle attached to said second terminal end of said shoulder harness restraint and to said shoulder belt.

6. The passive restraint system of claim 1, further including a shoulder belt buckle having one or more passage formed therethrough, said shoulder belt buckle being attached to the vehicle and wherein said shoulder belt shoulder attachment end passes through one of said one or more passage.

7. The passive restraint system of claim 6, further including a retaining member attached to the vehicle at one end thereof and said shoulder harness restraint at a second end thereof to hold the shoulder harness restraint in a desired position.

8. A passive restraint system in a vehicle for restraining an occupant, comprising:
a lap-shoulder belt assembly including a shoulder belt and a seat belt; and
a shoulder harness restraint attached to said shoulder belt so as to provide a close fit of said shoulder belt to the occupant when the seat of the vehicle is in either of an upright and an inclined condition.
